(19) United States
(12) Patent Application Publication
(10) Pub. No.: US 2025/0105775 A1
(43) Pub. Date: Mar. 27, 2025

(54) SKIP RAIL SYSTEM

(71) Applicant: Pegasus Solar Inc, Richmond, CA (US)

(72) Inventors: Erich Kai Stephan, Richmond, CA (US); Glenn Harris, Richmond, CA (US); Nicholas Wenzel, Richmond, CA (US); Peter Wilke, Richmond, CA (US)

(21) Appl. No.: 18/972,650

(22) Filed: Dec. 6, 2024

Related U.S. Application Data
(63) Continuation of application No. 18/515,134, filed on Nov. 20, 2023.
Application No. 18/515,134 is a continuation of application No. 16/889,635, filed on Jun. 1, 2020, now Pat. No. 11,848,636.
(60) Provisional application No. 62/857,176, filed on Jun. 4, 2019.

(51) Int. Cl. H02S 20/23; F24S 25/61; F24S 25/67

(52) U.S. Cl. CPC H02S 20/23; F24S 25/61; F24S 25/67

(57) ABSTRACT

A multi-rail system for mounting solar modules to a surface, such as a roof, uses two rails to support a first row of solar modules, and a single rail to support each subsequent row of solar modules. Splices connect edges of solar modules between rows, providing support along one edge of the solar modules for the subsequent rows.

### CROSS-REFERENCE TO RELATED APPLICATION

This application is a continuation of U.S. patent application Ser. No. 18/515,134 entitled “SKIP RAIL SYSTEM,” filed on Nov. 20, 2023, which is a continuation of U.S. patent application Ser. No. 16/889,635 entitled “SKIP RAIL SYSTEM,” filed on Jun. 1, 2020, now U.S. Pat. No. 11,848,636, which claims the benefit of U.S. Provisional Application No. 62/857,176 entitled “SKIP RAIL SYSTEM,” filed on Jun. 4, 2019, the full disclosures of which are incorporated herein in their entirety.

### BACKGROUND

Current solar mounting solutions using rails as mounting structure require two rails per each row of solar modules. Each row takes additional time to install and increases the number of roof penetrations, which in turn increases installation labor and the risk of a roof leak. A solution which reduces the number of rows of rails is beneficial for time and cost savings along with risk reduction.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be limiting of its scope, the principles herein are described and explained with additional specificity and detail through the use of the accompanying drawings in which:

FIG. 1A illustrates an isometric view of a Skip rail splice;

FIG. 1B illustrates a Skip rail splice and a solar module being installed;

FIG. 1C illustrates a Skip rail splice with a solar module installed on one side and another in process of being installed;

FIG. 1D illustrates a Skip rail splice and solar module assembly in final assembly state, side profile;

FIG. 2A illustrates an isometric view of an alternative embodiment of a Skip rail splice;

FIG. 2B illustrates an alternative embodiment of a Skip rail splice and a solar module being installed;

FIG. 2C illustrates an alternative embodiment of a Skip rail splice with a solar module installed on one side and another in process of being installed;

FIG. 2D illustrates an alternative embodiment of a Skip rail splice and solar module assembly in final assembly state, side profile;

FIG. 3 illustrates an isometric view of another alternative embodiment of a Skip rail splice; and

FIGS. 4-11 illustrate embodiments of a system of Skip rail splices.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

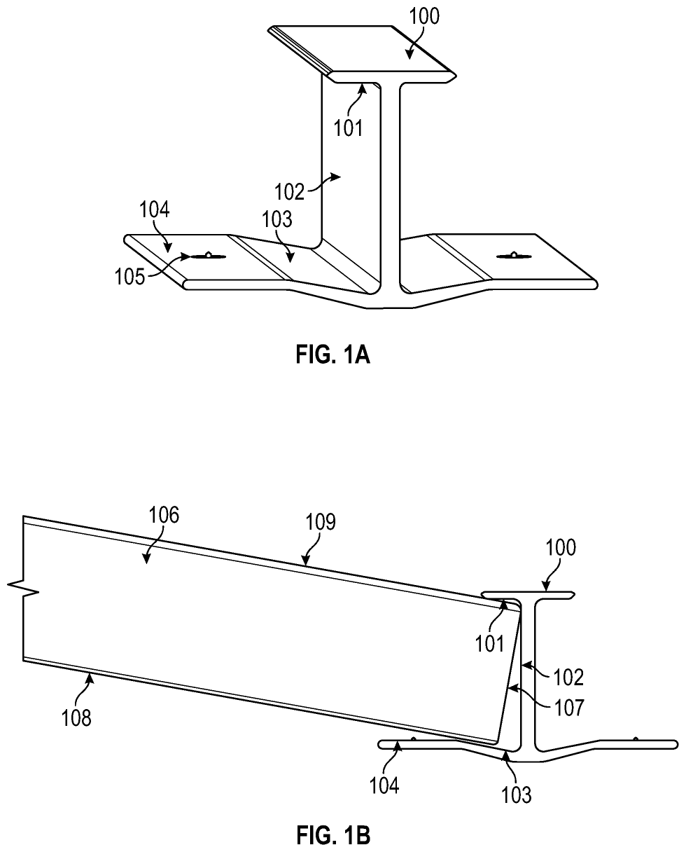

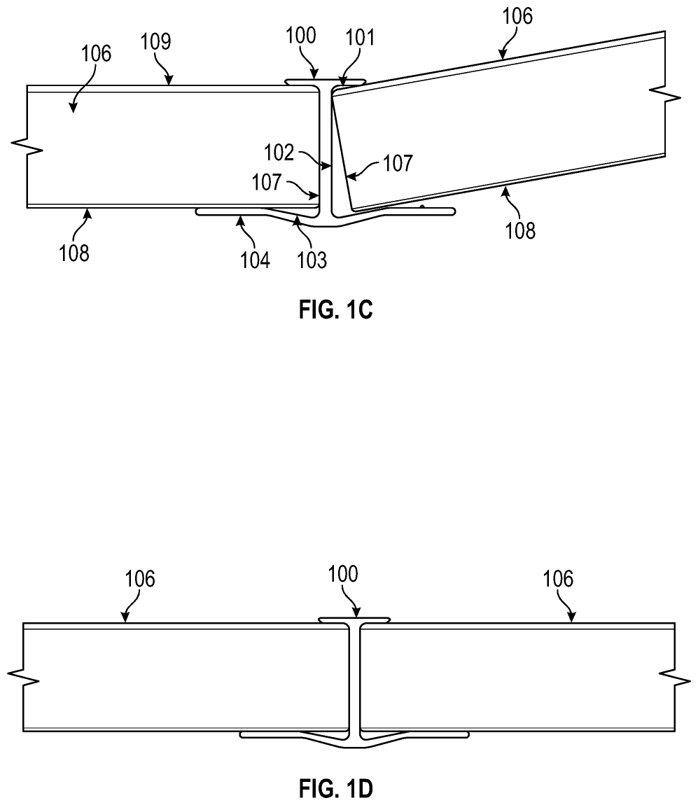

FIG. 1A depicts an isometric view of the skip rail splice 100. The skip rail splice 100 is comprised of two horizontal members 101 extending from center vertical member 102. Extending from bottom of vertical member 102 are angled members 103 which are at an angle between 0-90 degrees from the vertical member 102. The angled members 103 transition to bottom flanges 104 which may be substantially parallel to top horizontal members 101 or may be at an angle relative to top horizontal members 101. There may be one or more apertures on the face of bottom flanges 104 which may have a bond pin 105 inserted. The bond pin 105 serves the purpose of making electrical bonding connection to the solar module upon installation into the skip rail splice 100.

FIG. 1B depicts a solar module 106 being installed into a skip rail splice 100 from a side view. The solar module 106 may be inserted with the bottom edge 108 at angle relative to bottom flanges 104. The solar module 106 may then be angled down so that bottom edge 108 is substantially parallel with top horizontal member 101.

FIG. 1C depicts one solar module 106 on the left side in its final installation state where the top edge 109 of solar module 106 is in contact with top horizontal member 101. Leading edge 107 is coincident or in proximity with vertical member 102. Bottom edge 108 may be in contact with bottom flange 104. When the first solar module 106 is in the lowered position shown in FIG. 1C, the bottom flange 104 and the top horizontal member 101 may compress the frame of solar module 106 sufficiently to secure the solar module 106 from typical forces. In this example embodiment, the vertical distance between the top horizontal member 101 and the bottom flange 104 is slightly less than the vertical height of the frame of the solar module 106 in order to create a clamping force. The second solar module 106 on the right edge of skip rail splice 100 is mid-installation in substantially the same process as the left first solar module of FIG. 1B.

FIG. 1D depicts both solar modules 106 in their final install state with skip rail splice 100. In this example embodiment, the first and second solar modules 106 are substantially parallel with one another, and substantially parallel with the horizontal member 104 of the skip rail splice 100.

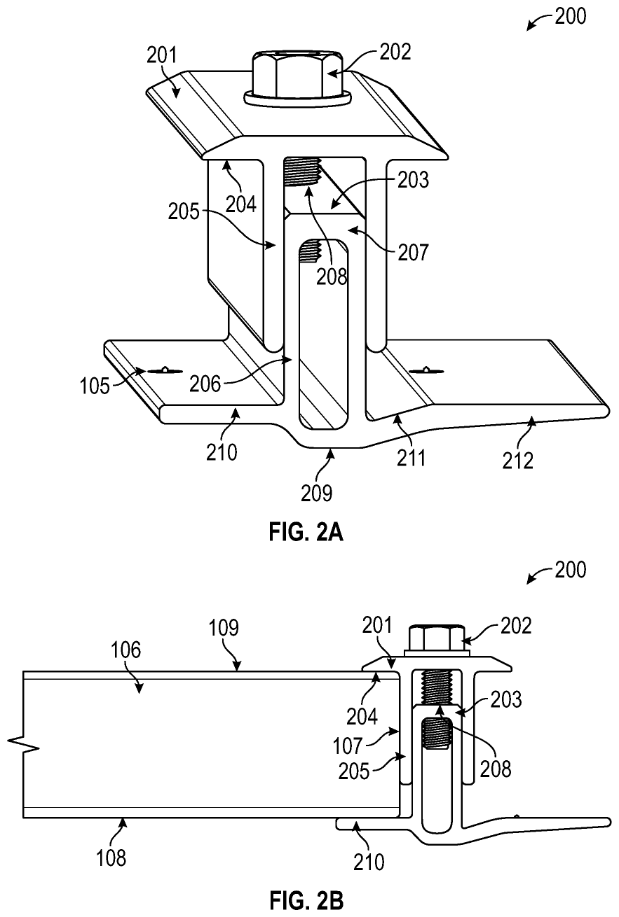

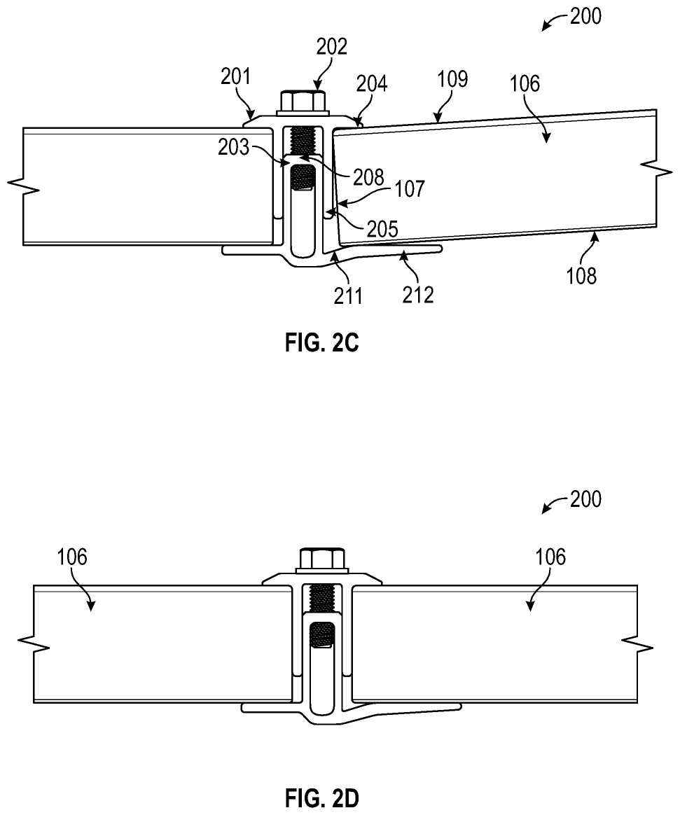

FIG. 2A depicts an isometric view of an alternative embodiment of the skip rail splice 200. The skip rail splice 200 is comprised of a top piece 201, bottom piece 203, and a fastener 202. The top piece 201 has horizontal members 204 protruding from a main body comprised of two vertical members 205 which have a “U” shape with opening at the bottom. The material between horizontal members 201 may have an aperture for fastener 202 to pass through. The bottom piece 203 of the assembly may be comprised of two vertical members 206 with a space between the two outer walls less than the width of the space between the two inner members 205 of the top piece 201. These two vertical members 206 are connected at the top by a horizontal member 207 and at the bottom with a horizontal member 209. Member 207 may have a threaded aperture 208 for receiving threaded fastener 202 which when turned, threadably tightens top piece 201 in the downward direction bringing horizontal members 204 closer to horizontal members 210 and 212 of the bottom piece 203. There may be one or more apertures on the face of horizontal members 210 and 212 which may have a bond pin 105 inserted inside said aperture. The bond pin 105 serves the purpose of making electrical bonding connection to the solar module which will be installed into the Skip rail splice 200.

FIG. 2B depicts a first solar module 106 on the left side in its final installation state where the top edge 109 of solar module 106 is in contact with horizontal member 204. Leading edge 107 is in contact with vertical member 205. Bottom edge 108 is in contact with horizontal member 210. When solar module 106 is in the position shown the fastener 202 is threadably tightened to secure or clamp the solar module between top piece 201 and bottom piece 203.

FIG. 2C depicts a solar module 106 being installed into the right side of skip rail splice 200 from a side view. The solar module 106 may be inserted with the bottom edge 108 at an angle similar to the angled member 211. Once the corner edge, between top edge 109 and leading edge 107, is positioned in contact or substantially close with vertical member 205, the solar module 106 may be angled down into its final install state shown in FIG. 2D.

FIG. 2D depicts both solar modules 106 in their final install state with skip rail splice 200.

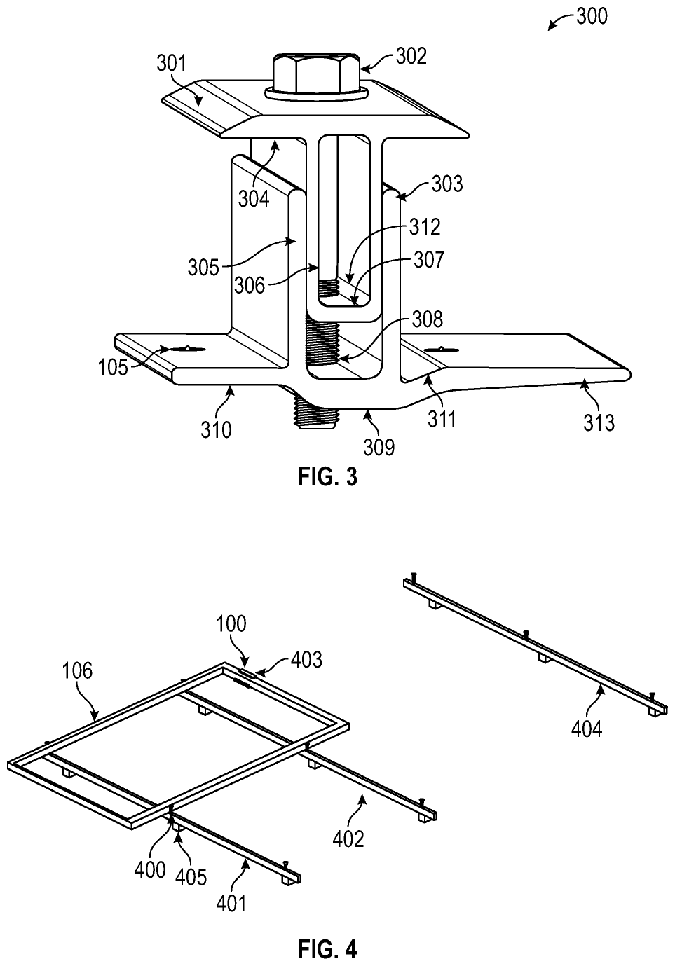

FIG. 3 depicts an isometric view of an alternative embodiment of the skip rail splice 300. The skip rail splice 300 is comprised of a top piece 301, bottom piece 303, and a fastener 302. The top piece 301 has horizontal members 304 protruding from a main body comprised of two vertical members 306 and third member 307 connecting the two. The bottom member 307 may have an aperture 312 for fastener 302 to pass through. The bottom piece 303 of the assembly may be comprised of two vertical members 305 with a space between the two inner walls greater than the width of the two outer members 306 of the top piece 301. These two vertical members 305 are connected by a third member 309, creating a “U” shape. The third member 309 may have a threaded aperture for receiving threaded fastener 302 which when turned, threadably tightens or clamps top piece 301 in the downward direction bringing horizontal members 304 closer to horizontal members 310 and 313 of the bottom piece 303. There may be one or more apertures on the face of horizontal members 310 and 313 which may have a bond pin 105 inserted inside said aperture. The bond pin 105 serves the purpose of making electrical bonding connection to the solar module which will be installed into the skip rail splice 300.

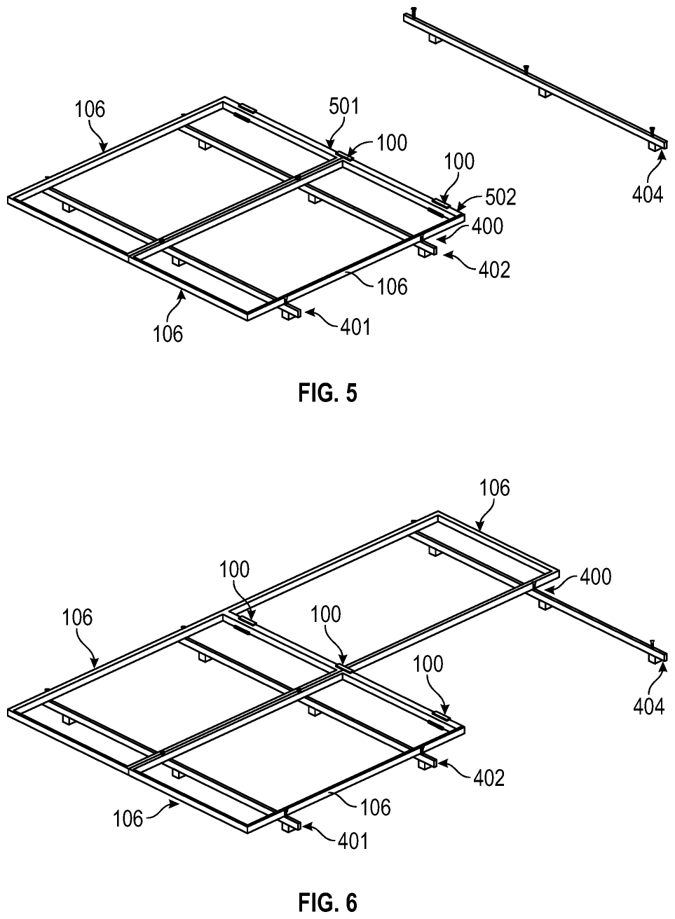

FIGS. 4 through 11 show installation examples of a system of skip rail splices 100. These example systems are possible with the example embodiments shown in FIGS. 1 through 3. Typical solar installation systems require two rows of rails per row of solar modules 106, but in utilizing a skip rail splice 100, the array of solar modules often only requires one row of rails for solar module rows two and above within a solar array.

FIG. 4 is an example embodiment of the present invention depicting a solar module 106 installed in a portrait orientation on a first rail 401 and a second rail 402. The first rail 401, second rail 402, and third rail 404 are all attached to a roof surface using a mount 405. The solar module 106 is secured to the first rail 401 and second rail 402 by clamps 400 at each of the four locations where the frame of the solar module 106 contacts the rails. A first skip rail splice 100 is positioned at row-end splice location 403. In this example embodiment, a first rail 401 is positioned within the first half of a solar module 106, and the second rail 402 is positioned substantially parallel with the first rail 401 in the second half of solar module 106. For a second row of solar modules (not shown), a third rail 404 is positioned substantially parallel to the first two rails, in a position that would align in the farthest half of a to-be-installed solar module above the first solar module 106. In this example embodiment, there is no rail positioned in the lower half of a solar module in the second row of the array.

FIG. 5 depicts a possible next step in the installation of the array of solar modules 106. One or more solar modules 106 are attached in the same row as the first solar module 106 to rails 401 and 402. On the top edge of the solar modules 106, a skip rail splice 100 is attached. One or more skip rail splices 100 are attached per solar module 106 along length of top edge and there may be a skip rail splice 100 that is attached to two solar modules 106 at mid-row splice location 501. A third skip rail splice 100 is located at the right edge of a right-end splice location 502. In other example embodiments, a row of solar modules 106 may have a skip rail splice 100 at multiple mid-row splice locations 501.

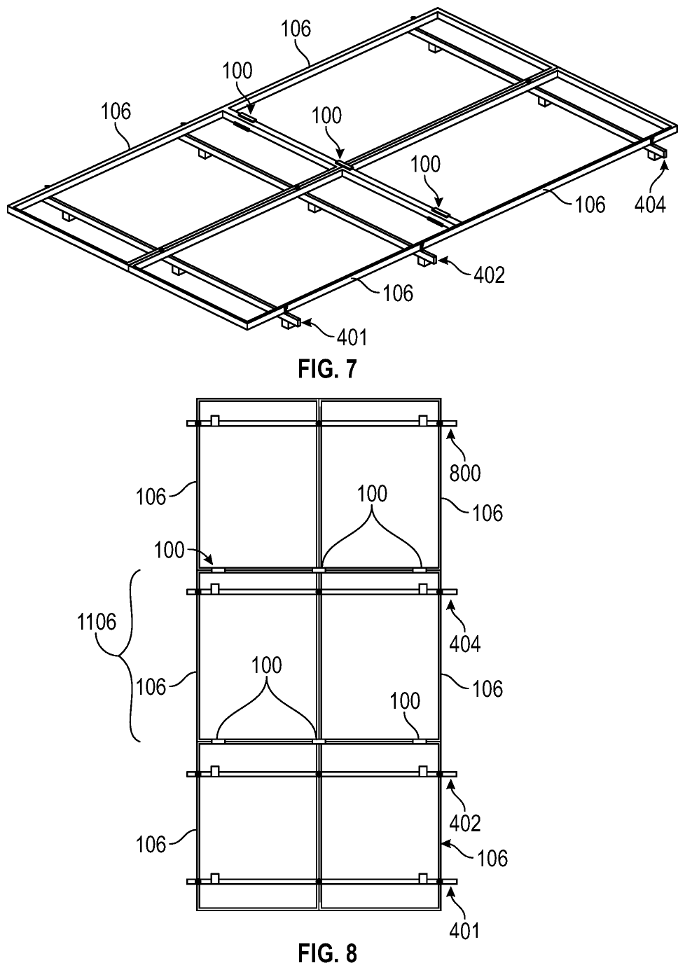

FIG. 6 depicts a possible next step in the installation of the array of solar modules 106. A solar module 106 is installed above first row of solar modules 106. The bottom edge of the solar module 106 is installed into the top edge of one or more skip rail splices 100 which were installed on top edge of solar modules in the previous step shown in FIG. 5. The example method of installing solar module 106 into skip rail splice 100 can be seen in the depiction in FIGS. 1C-1D and FIGS. 2C-2D. Next, the sides of the frame on module 106 are secured to the third rail 404 with clamp(s) 400.

FIG. 7 depicts a possible next step in the installation of the array of solar modules 106. One or more solar modules 106 are installed in the second row next to the first solar modules 106 shown in FIG. 6. These solar modules 106 are installed in substantially the same process as described in previous steps, including the example method depicted in FIGS. 1C-1D and FIGS. 2C-2D. The bottom edge of the solar module 106 may install into the top edge of a skip rail splice 100 shared with a module in the same row immediately to the left or right. If the solar module 106 is the outermost solar module of the row in the array, it may be the only solar module 106 installed into the top edge of a skip rail splice 100 located in an end splice location 502.

FIG. 8 depicts an example embodiment from an overhead view showing a solar module array with three rows of 2 solar modules each. In this example embodiment of the present invention, the three rows of solar modules 106 employ 4 rows for rails and two rows of skip rail splices 100. In this example embodiment, a first rail 401 is positioned within the first half of a solar module 106, and the second rail 402 is positioned substantially parallel with the first rail 401 in the second half of the same solar module 106. For a second row of solar modules 106, a third rail 404 is positioned substantially parallel to the first two rails, in a position that aligns it in the farthest half of the second row of solar modules 106 above the first row of solar modules 106. In this example embodiment, there is no rail positioned in the lower half of the solar modules 106 in the second row of the array. A fourth rail 800 is positioned substantially parallel to the first three rails, in a position that would align in the farthest half of the third row of solar modules 106. In this example embodiment, there is no rail positioned in the lower half of the solar modules 106 in the third row of the array. As depicted, the spacing between the second rail 402 and the third rail 404, and the spacing between the third rail 404 and the fourth rail 800, generally correspond to the length of the longer edge 1106 of the second row of solar modules.

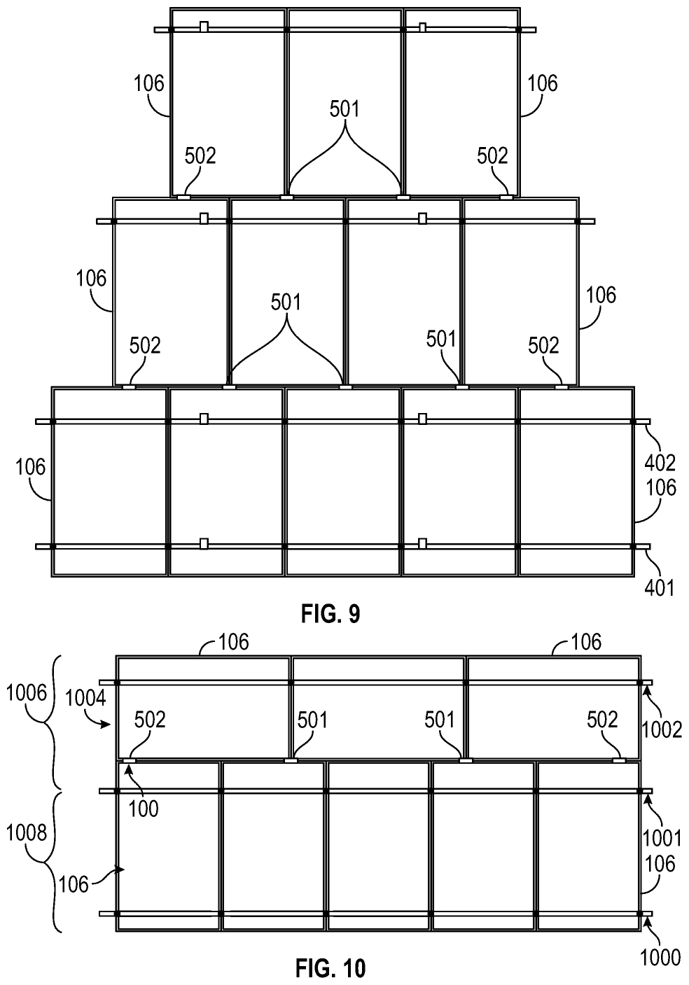

FIG. 9 depicts an example embodiment of an array of solar modules 106 with different numbers of solar modules 106 in the different rows of the array. Between each of the rows of solar modules 106 there is a row of skip rail spices 100 which may have two skip rail splices 100 in row-end splice locations 502 and multiple skip rail splices 100 in mid-row splice locations 501. Each of these skip rail splices 100 may attach to two, three, or four solar modules 106. As depicted, the skip rail splices 100 that are positioned in mid-row splice locations 501 are positioned to connect one solar module 106 in the solar module row below the skip rail splice 100 and two solar modules 106 in the solar module row above the skip rail splice 100. Skip rail splices 100 that are positioned in row-end splice locations 502 connect one solar module 106 from the row above and one solar module 106 from the row below skip rail splice 100. FIG. 9 depicts an example embodiment of an array of solar modules where alignment of the modules alternates from one row to the next, and the number of modules in each row decreases for each added row.

FIG. 10 depicts an example embodiment of an array of solar modules of mixed landscape 1006 and portrait 1008 orientations. Between the rows of solar modules 106 there is a row of skip rail spices 100 which may have two skip rail splices 100 in row-end splice locations 502 and multiple skip rail splices 100 in mid-row splice locations 501. Each of these skip rail splices 100 may attach to two, three, or four solar modules 106. In this example embodiment, a first rail 1000 is positioned within the first half of a solar module 106, and the second rail 1001 is positioned substantially parallel with the first rail 1000 in the second half of solar module 106. For the second row of solar modules 106 in landscape 1006 orientation, a third rail 1002 is positioned substantially parallel to the first two rails, in a position that aligns it in the farthest half of the edge of a row of solar modules 106 above the first row of solar modules 106. In this example embodiment, there is no rail positioned in the lower half of the solar modules 106 in the second row of the array. The spacing between the second rail 1001 and the third rail 1002 generally corresponds to the length of the shorter edge 1004 of the second row of solar modules. As depicted, the skip rail splices 100 that are positioned in mid-row splice locations 501 are positioned to connect one solar module 106 in the solar module row below the skip rail splice 100 and two solar modules 106 in the solar module row above the skip rail splice 100. Skip rail splices 100 that are positioned in row-end splice locations 502 connect one solar module 106 from the row above and one solar module 106 from the row below skip rail splice 100.

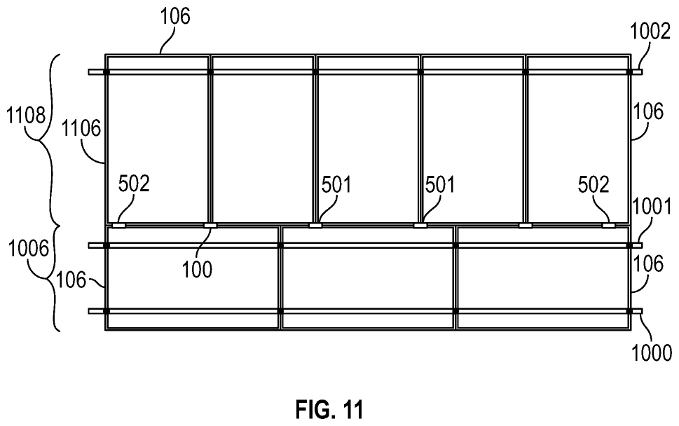

FIG. 11 depicts an example embodiment of an array of solar modules of mixed landscape 1006 and portrait 1108 orientations. Between the rows of solar modules 106 there is a row of skip rail spices 100 which may have two skip rail splices 100 in row-end splice locations 502 and multiple skip rail splices 100 in mid-row splice locations 501. Each of these skip rail splices 100 may attach to two, three, or four solar modules 106. In this example embodiment, a first rail 1000 is positioned within the first half of a solar module 106, and the second rail 1001 is positioned substantially parallel with the first rail 1000 in the second half of solar module 106. For the second row of solar modules 106 in portrait 1108 orientation, a third rail 1002 is positioned substantially parallel to the first two rails, in a position that aligns it in the farthest half of the edge of a row of solar modules 106 above the first row of solar modules 106. In this example embodiment, there is no rail positioned in the lower half of the solar modules 106 in the second row of the array. The spacing between the second rail 1001 and the third rail 1002 generally corresponds to the length of the longer edge 1106 of the second row of solar modules. As depicted, the skip rail splices 100 that are positioned in mid-row splice locations 501 are positioned to connect one solar module 106 in the solar module row below the skip rail splice 100 and two solar modules 106 in the solar module row above the skip rail splice 100. Skip rail splices 100 that are positioned in row-end splice locations 502 connect one solar module 106 from the row above and one solar module 106 from the row below skip rail splice 100.

Unless specifically stated, the terms and expressions have been used herein as terms of description and not terms of limitation. There is no intention to use the terms or expressions to exclude any equivalents of features shown and described or portions thereof and this invention should be defined in accordance with the claims that follow.

What is claimed is:

1. A mounting system for solar modules, the system comprising:
a pair of mounting rails attached to a roof surface and used to support a first solar module having a first edge and a second edge opposite the first edge, wherein the pair of mounting rails extends in parallel along an interior portion of the first solar module between the first edge and the second edge; and
an edge splice configured to connect the second edge of the first solar module to a first edge of a second solar module supported by a single additional mounting rail, wherein the edge splice is laterally displaced from the pair of mounting rails and the single additional mounting rail.

2. The mounting system of claim 1, further comprising:
a second additional mounting rail attached to the roof surface, laterally displaced from the single additional mounting rail, and parallel to the single additional mounting rail, wherein the second additional mounting rail is positioned along an interior portion of a third solar module; and
a second edge splice laterally displaced from the single additional mounting rail and that connects a first edge of the third solar module to a second edge of the second solar module.

3. The mounting system of claim 1, wherein the first edge of the first solar module and the first edge of the second solar module are parallel to the pair of mounting rails.

4. The mounting system of claim 1, wherein a first mounting rail of the pair of mounting rails is positioned within a first half portion of the first solar module, wherein a second mounting rail of the pair of mounting rails is positioned within a second half portion of the first solar module, and wherein the single additional mounting rail is positioned within a half portion of the second solar module that is farthest from the first solar module.

5. The mounting system of claim 1, wherein a first distance between the pair of mounting rails corresponds to a fraction of a length of a third edge of the first solar module, the third edge of the first solar module orthogonal to the first edge of the first solar module.

6. The mounting system of claim 1, wherein a length of the first edge of the first solar module is different than a length of the first edge of the second solar module.

7. The mounting system of claim 1, further comprising:
a third solar module that has a first edge and a second edge, wherein the first edge of the third solar module is substantially aligned with the first edge of the first solar module;
a fourth solar module with a first edge and a second edge, wherein the second edge of the fourth solar module is substantially aligned with the second edge of the second solar module; and
a second edge splice that connects the second edge of the first solar module and the second edge of the third solar module to the first edge of the second solar module and the first edge of the fourth solar module.

8. The mounting system of claim 1, further comprising:
a third solar module with a first edge that is substantially aligned with the first edge of the first solar module; and
a second edge splice that connects the first edge of the second solar module to a second edge of the third solar module.

9. The mounting system of claim 1, wherein the single additional mounting rail is configured to support the second solar module along an interior portion of the second solar module between the first edge and a second edge of the second solar module.

10. A mounting system for solar modules, the system comprising:
a pair of mounting rails attached to a roof surface and used to support a first row of one or more solar modules each having a first edge and a second edge opposite the first edge, wherein the pair of mounting rails extends in parallel along a respective interior portion of each of the first row of solar modules between the respective first edge and the respective second edge of each of the first row of solar modules;
a single additional mounting rail that supports a second row of one or more solar modules, wherein the single additional mounting rail is positioned along a respective interior portion of each of the second row of solar modules; and
an end-row edge splice configured to connect a solar module in the first row to a solar module at an end of the second row, the end-row edge splice laterally displaced from the pair of mounting rails and the single additional mounting rail.

11. The mounting system of claim 10, further comprising a mid-row edge splice configured to connect a solar module located mid-row within the first row to two solar modules of the second row.

12. The system of claim 10, wherein each of the one or more solar modules in the second row has a first edge and a second edge opposite the first edge, and wherein a third edge of at least one of the solar modules of the first row is aligned to a third edge of at least one of the solar modules of the second row, the third edge of the at least one solar module of the first row being orthogonal to the respective first edge of the at least one solar module of the first row.

13. The mounting system of claim 10, wherein third edges of solar modules of the first row are offset from corresponding third edges of solar modules of the second row.

14. The mounting system of claim 10, further comprising a second single additional mounting rail that supports a third row of one or more solar modules.

15. The mounting system of claim 10, wherein the solar modules of the first row are in a different orientation than the solar modules of the second row.

16. The mounting system of claim 10, wherein the first edge of one of the solar modules in the first row is parallel with the pair of mounting rails, the first edge having a first length, and wherein one of the solar modules in the second row has a third edge that is parallel with the pair of mounting rails, the third edge of the solar module in the second row having a different length than the first edge of the solar module in the first row.

17. A method for installing solar modules using a mounting system, the method comprising:
attaching a pair of mounting rails and a single additional rail to a roof surface with a plurality of mounts;
attaching a first solar module to the pair of mounting rails using clamps, wherein the first solar module has a first edge and a second edge opposite of the first edge, and wherein the pair of mounting rails are positioned along an interior portion of the first solar module between the first edge and the second edge;
connecting the second edge of the first solar module to a first edge of a second solar module using an edge splice, wherein the edge splice is laterally displaced from the pair of mounting rails; and
attaching the second solar module to the single additional mounting rail, wherein the single additional mounting rail is positioned along an interior portion of the second solar module between the first edge and a second edge of the second solar module.

18. The method of claim 17, further comprising:
attaching a second additional mounting rail to the roof surface, the second additional mounting rail laterally displaced from the single additional mounting rail and parallel to the single additional mounting rail;
connecting a second edge of the second solar module to a first edge of a third solar module using a second edge splice; and
attaching the third solar module to the second additional mounting rail.

19. The method of claim 17, wherein the single additional mounting rail is positioned within a half portion of the second solar module that is farthest from the first solar module.

20. The method of claim 17, wherein a distance between the pair of mounting rails is a fraction of a length of a third edge of the first solar module, the third edge of the first solar module orthogonal to the first edge of the first solar module.

21. The method of claim 17, further comprising:
attaching a third solar module to the pair of mounting rails; and
connecting a second edge of the third solar module to the first edge of the second solar module using a second edge splice.

22. The method of claim 21, further comprising attaching the third solar module to the pair of mounting rails along an interior portion of the third solar module between a first edge and the second edge of the third solar module.

23. The method of claim 17, wherein a length of the first edge of the first solar module is different than a length of the first edge of the second solar module.

24. The method of claim 17, further comprising connecting the second edge of the first solar module to the first edge of the second solar module using a second edge splice.
